(19) United States
(12) Patent Application Publication
(10) Pub. No.: US 2024/0280740 A1
(43) Pub. Date: Aug. 22, 2024

(54) OPTICAL FILMS FOR DISPLAY SYSTEMS

(71) Applicant: 3M INNOVATIVE PROPERTIES COMPANY, St. Paul, MN (US)

(72) Inventors: Heykyoung Han, Suwon-si (KR); Jihoon Yu, Gwangmyeong-si (KR); John F. VanDerlofske, III, Minneapolis, MN (US); Raghunath Padiyath, Woodbury, MN (US); John F. Reed, North Oaks, MN (US); Carl A. Stover, North Oaks, MN (US)

(21) Appl. No.: 18/570,774

(22) PCT Filed: Jun. 20, 2022
(86) PCT No.: PCT/IB2022/055720

§ 371 Date: Dec. 15, 2023

Related U.S. Application Data
(60) Provisional application No. 63/202,859, filed on Jun. 28, 2021.

(51) Int. Cl. G02B 5/30; G02C 7/12

(52) U.S. Cl. CPC G02B 5/305; G02B 5/3083; G02C 7/12

(57) ABSTRACT

An optical construction includes an optical film including a plurality of polymeric layers and an optical retarder disposed on the optical film. For a substantially normally incident light and for a visible wavelength range of about 420 nm to about 680 nm and an infrared wavelength range of about 900 nm to about 1100 nm: for the incident light polarized along each of mutually orthogonal in-plane first and second directions. the plurality of polymeric layers has an optical transmittance of greater than about 60% for at least one visible wavelength in the visible wavelength range and an optical reflectance of greater than about 60% for at least one infrared wavelength in the infrared wavelength range. For the incident light polarized along at least one of the first and second directions, the optical retarder has an optical retardance of greater than about 1000 nm at the at least one visible wavelength.

### TECHNICAL FIELD

The disclosure generally relates to optical constructions, particularly optical constructions including multilayer optical films for display systems.

### BACKGROUND

Multilayer optical films (MOF) are used in display systems and other applications. In some cases, MOF used in outdoor displays, such as public information displays that are exposed to the sun, may include infrared (IR) reflective polymeric films that reflect wavelengths of light from the sun in the infrared region while allowing visible light to pass through. Some multilayer optical films may be non-metallic films with enhanced solar performance and minimal color shift.

### SUMMARY

Some aspects of the disclosure relate to an optical construction including an optical film including a plurality of polymeric layers numbering at least 10 in total. Each of the polymeric layers have an average thickness of less than about 500 nm. An optical retarder is disposed on the optical film. For a substantially normally incident light and for a visible wavelength range extending from about 420 nm to about 680 nm and an infrared wavelength range extending from about 900 nm to about 1100 nm and for the incident light polarized along each of mutually orthogonal in-plane first and second directions, the plurality of polymeric layers has an optical transmittance of greater than about 60% for at least one visible wavelength in the visible wavelength range and an optical reflectance of greater than about 60% for at least one infrared wavelength in the infrared wavelength range. Further, for the incident light polarized along at least one of the first and second directions, the optical retarder has an optical retardance of greater than about 1000 nm at the at least one visible wavelength.

Some other aspects of the disclosure relate to an outdoor display configured to be used outdoors and exposed to the sun. The outdoor display includes a display configured to emit a polarized image for outdoor viewing by a viewer. A multilayer polymeric optical film disposed on the display includes a plurality of polymeric layers, each of the polymeric layers having an average thickness of less than about 500 nm. The optical film is substantially polarization insensitive and configured to substantially transmit the polarized image emitted by the display and substantially reflect at least a portion of infrared light received from the sun. An optical retarder is disposed between the optical film and the display and has a retardance of greater than about 1000 nm at at least one visible wavelength.

Other aspects of the disclosure relate to a display system including a display configured to emit a polarized image for viewing by a viewer and an optical construction of one or more aspects of the disclosure disposed on the display so that the optical construction is disposed between the display and the viewer.

Some other aspects of the disclosure relate to outdoor displays having a display system according to one or embodiments of the disclosure.

### BRIEF DESCRIPTION OF DRAWINGS

The various aspects of the disclosure will be discussed in greater detail with reference to the accompanying figures where,

FIG. 1 schematically shows an optical construction including a multilayer optical film according to some embodiments of the disclosure:

FIG. 2 shows the optical transmittance of the multilayer optical film at different wavelengths according to some embodiments of the disclosure:

FIG. 3A schematically shows light incident on the multilayer optical film where the incident light is s-polarized:

FIG. 3B schematically shows light incident on the multilayer optical film where the incident light is p-polarized:

FIGS. 4A and 4B schematically illustrate display systems including a display configured to emit a polarized image according to some embodiments; and

FIG. 4C schematically shows an outdoor display including a display system according to some aspects of the disclosure:

The figures are not necessarily to scale. Like numbers used in the figures refer to like components. However, it will be understood that the use of a number to refer to a component in a given figure is not intended to limit the component in another figure labelled with the same number.

### DETAILED DESCRIPTION OF ILLUSTRATIVE EMBODIMENTS

In the following description, reference is made to the accompanying drawings that form a part hereof and in which various embodiments are shown by way of illustration. It is to be understood that other embodiments are contemplated and may be made without departing from the scope or spirit of the present description. The following detailed description, therefore, is not to be taken in a limiting sense.

MOF based IR mirror films improve thermal performance by reflecting infrared of sunlight. 3M™ UCSF (Ultra Clear Solar Film) is one such MOF based IR mirror film that has a transmittance of about 90% in visible light without affecting the display quality and a reflectance of about 90% in the NIR (800-1200 nm) region of sunlight. Viewers who look at outdoor displays often use polarized sunglasses for anti-glare purposes. If a viewer wearing polarized sunglasses looks at an outdoor display having the MOF based IR mirror film attached to the front of the display, the viewer may see an irregular color distribution, also known as color mura, that may cause a lack of clarity in the image being viewed. The embodiments disclosed herein addresses these and other challenges.

Some embodiments of the disclosure relate to MOF based IR mirror films combined with high retardation films to reduce or eliminate color mura and obtain sunglass compatibility.

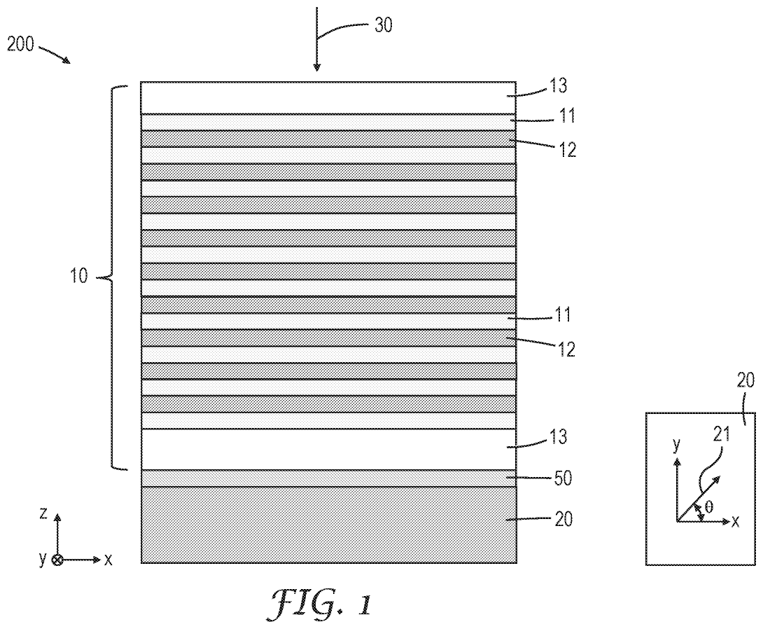

Some embodiments of an optical construction including a multilayer optical film is shown in FIG. 1. The optical construction (200) may include an optical film (10) having a plurality of polymeric layers (11, 12). The plurality of polymeric layers (11, 12) may include at least 10, or 50, or 100, or 200, or 300 layers in total. The average thickness of each of the polymeric layers (11, 12) may be less than about 500 nm, or less than 400 nm, or less than 300 nm or less than 200 nm. In some embodiments, the number of layers in the optical film (10) may be selected to achieve the desired optical properties using the minimum number of layers for reasons of film thickness, flexibility and economy. In some cases, the optical film may further include one or more polymeric skin layers (13) disposed on the plurality of polymeric layers (11, 12). Each of the skin layers (13) may have an average thickness of greater than about 500 nm, or greater than 750 nm, or greater than 1000 nm, or greater than 1250 nm, or greater than 1500 nm. The skin layers (13) and the plurality of polymeric layers (11, 12) may be bonded with each other using adhesives. The skin layer (13), for instance, may be made of polycarbonate or polycarbonate alloy, or polyethylene terephthalate (PET), or polystyrene (PS), or a combination thereof.

In some embodiments, the plurality of polymeric layers may include a plurality of alternating polymeric different first (11) and second (12) layers. For instance, the optical film (10) may include alternating first (11) and second (12) polymeric layers including at least one birefringent polymer (e.g. oriented semi-crystalline polymer) and one second polymer.

In other embodiments, the materials of first and second layers (11, 12) may be composed of polymers such as polyesters. For instance, an exemplary polymer useful as a first birefringent layer (11) may be polyethylene naphthalate (PEN). Other semicrystalline polyesters suitable as birefringent polymers as the first birefringent layer (11) in the multilayer polymeric film may include, for example, polybutylene 2,6-naphthalate (PBN), polyethylene terephthalate (PET), or the like. The second layer (12) can be made from a variety of polymers having glass transition temperatures compatible with that of the first birefringent polymer layer (11) and having a refractive index similar to the isotropic refractive index of the first birefringent polymer layer (11). Examples of other polymers suitable for use in optical films and, particularly, in the second polymer layer (12) may include vinyl polymers and copolymers made from monomers such as vinyl naphthalenes, styrene, maleic anhydride, acrylates, and methacrylates. Examples of such polymers for the second polymer layer (12) include polyacrylates. polymethacrylates, such as poly methyl methacrylate (PMMA), and isotactic or syndiotactic polystyrene. Other polymers include condensation polymers such as polysulfones, polyamides, polyurethanes, polyamic acids, and polyimides. In addition, the second polymer layer (12) can be formed from homopolymers and copolymers of polyesters, polycarbonates, fluoropolymers, and polydimethylsiloxanes, and blends thereof. The layers can be selected to achieve the reflection of a specific bandwidth of electromagnetic radiation.

In one embodiment, the materials of the plurality of layers (11, 12) may have differing indices of refraction. In some embodiments, the optical film (10) may include PET as the first optical layer (11) and co polymers of PMMA (coPMMA), or any other polymer having low refractive index, including copolyesters, fluorinated polymers or combinations thereof as the second optical layer (12). The transmission and reflection characteristics of the optical film (10) may be based on coherent interference of light caused by the refractive index difference between the layers (11, 12) and the thicknesses of layers (11, 12). According to some embodiments, each of the first and second layers (11, 12) may have respective indices of refraction nx along a same in-plane first direction (x-axis), an index ny along an in-plane second direction (y-axis) orthogonal to the first direction, and an index nz along a third direction (z-axis) orthogonal to the first and second directions. In some cases, nx of the first layers (11) may be greater than the nx of the second layers (12) by at least 0.05, or 0.07, or 0.09, or 0.11, or 0.13, or 0.14.

In some aspects, for the first layers (11), and at least at a wavelength of about 633 nm, a magnitude of a difference between nx and ny may be less than about 0.05, or 0.04, or 0.03, or 0.02, or 0.015, and each of nx and ny may be greater than nz by at least 0.05, or 0.07, or 0.09, or 0.11, or 0.13, or 0.14. In some instances, for the first layers (11), at least at a wavelength of about 633 nm, each of the nx and ny may be between about 1.6 and about 1.7, or between about 1.62 and about 1.68, or between about 1.63 and about 1.66,, and nz may be between about 1.45 and about 1.55, or between about 1.47 and about 1.53, or between about 1.49 and about 1.51.

In other aspects, for the second layers (12), and at least at a wavelength of about 633 nm, a magnitude of a maximum difference between nx, ny and nz may be less than about 0.03, or 0.02, or 0.015, or 0.01. In some instances, for the second layers (12), at least at a wavelength of about 633 nm, each of the nx, ny and nz may be between about 1.45 and about 1.54, or between about 1.47 and about 1.52, or between about 1.48 and about 1.5.

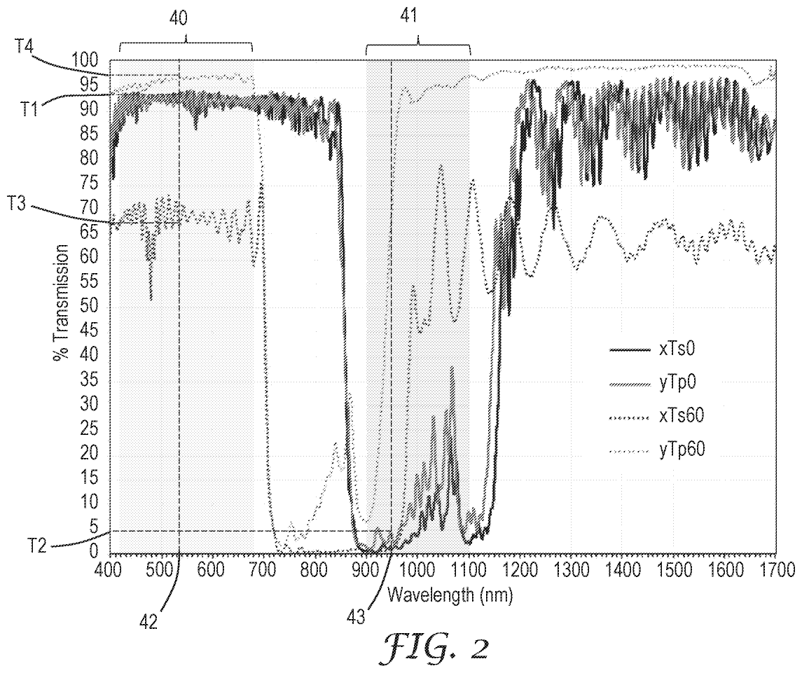

FIG. 2 shows the optical transmittance of the multilayer optical film at different wavelengths according to some embodiments of the disclosure. Light incident on the optical film is polarized along each of mutually orthogonal in-plane first (x-axis) and second (y-axis) directions.

In some embodiments, for a substantially normally incident light (30) and for the incident light polarized along each of mutually orthogonal in-plane first (x-axis) and second (y-axis) directions, the plurality of polymeric layers (11, 12) may have an average optical transmittance (T1) of greater than about 60%, or greater than about 70%, or greater than about 80%, or greater than about 85%, or greater than about 90% in a visible wavelength range (40) and an average optical reflectance (1−T2) of greater than about 60% in an infrared wavelength range (41).

In other aspects, for the substantially normally incident light (30) and for the incident light polarized along each of mutually orthogonal in-plane first (x-axis) and second (y-axis) directions, the plurality of polymeric layers (11, 12) may have an average optical transmittance (T1) of greater than about 60%, or greater than about 70%, or greater than about 80%, or greater than about 85%, or greater than about 90% for each wavelength in the visible wavelength range (40) and an average optical reflectance (1−T2) of greater than about 50%, or greater than about 55%, or greater than about 60% for each infrared wavelength in the infrared wavelength range (41).

In other aspects, as shown in FIG. 2, for a substantially normally incident light (30) and for a visible wavelength range (40) extending from about 420 nm to about 680 nm and an infrared wavelength range (41) extending from about 900 nm to about 1100 nm, for the incident light polarized along each of mutually orthogonal in-plane first (x-axis) and second (y-axis) directions, the plurality of polymeric layers (11, 12) may have an optical transmittance (T1) of greater than about 60% for at least one visible wavelength (42) in the visible wavelength range (40) and an optical reflectance (1−T2) of greater than about 60% for at least one infrared wavelength (43) in the infrared wavelength range (41). In some cases, the optical transmittance (T1) of the plurality of polymeric layers (11, 12) may be greater than about 70%, or 80%, or 85%, or 90% for at least one visible wavelength (42) in the visible wavelength range (40). In some cases, the optical reflectance (1−T2) of the plurality of polymeric layers (11, 12) may be greater than about 70%, or 80%, or 85%, or 90% for at least one infrared wavelength (43) in the infrared wavelength range (41).

In one or more embodiments, the optical film (10) may have an average optical reflectance of greater than about 60%, or greater than about 70%, or greater than about 80% in a visible wavelength range (40) extending from about 420 nm to about 680 nm. In an infrared wavelength range (41) extending from about 900 nm to about 1100 nm, an average optical reflectance of the optical film (10) may be greater than 40%, or 50%, or 60%, or 70%.

In some embodiments, the optical construction (200) includes an optical retarder (20) disposed on the optical film (10). The optical film (10) may be bonded to the optical retarder with a bonding layer (50). The bonding layer (50) may be, an optically clear adhesive layer, including, for instance, 3M™ Optically Clear Adhesives 8211/8212/8213/8214/8215/9483. The optical retarder (20) and the plurality of polymeric layers (11, 12) may be co-extruded.

In some embodiments, the optical retarder (20) may be a retardance layer having a retardance of greater than about 1000 nm at at least one visible wavelength. In some aspects, the retardance of the optical retarder may be greater than about 1250 nm, or greater than about 1500 nm, or greater than about 1750 nm, or greater than about 2000 nm, or greater than about 3000 nm, or greater than about 4000 nm, or greater than about 5000 nm at at least one visible wavelength.

As best shown in FIGS. 1 and 2, for a substantially normally incident light (30) and for a visible wavelength range (40) extending from about 420 nm to about 680 nm, and for the incident light polarized along at least one of the first (x-axis) and second (y-axis) directions, the optical retarder (20) may have an optical retardance of greater than about 1000 nm, or greater than about 1250 nm, or greater than about 1500 nm, or greater than about 1750 nm, or greater than about 2000 nm, or greater than about 3000 nm, or greater than about 4000 nm, or greater than about 5000 nm at the at least one visible wavelength (42).

In some cases, for the incident light (30) polarized along each of the first (x-axis) and second (y-axis) directions, the optical retarder (20) may have an optical retardance of greater than about 1000 nm, or about 1250 nm, or about 1500 nm, or about 1750 nm, or about 2000 nm, or about 3000 nm, or about 4000 nm, or about 5000 nm at at least one visible wavelength (42).

In some other cases, for the incident light (30) polarized along at least one of the first (x-axis) and second (y-axis) directions, the optical retarder (20) may have an optical retardance of greater than about 1000 nm, or greater than about 1250 nm, or greater than about 1500 nm, or greater than about 1750 nm, or greater than about 2000 nm, or greater than about 3000 nm, or greater than about 4000 nm, or greater than about 5000 nm at each at least one blue wavelength, at least one green wavelength, and at least one red wavelength.

As shown in FIG. 1, the optical retarder may include an in-plane slow axis (21). An in-plane slow axis of the retarder (20) refers to an axis in a direction corresponding to a larger one of principal refractive indices in an in-plane direction of the retarder (20). In some aspects, the in-plane slow axis (21) may make an angle (θ) of between about 30 degrees to about 60 degrees with the first direction (x-axis).

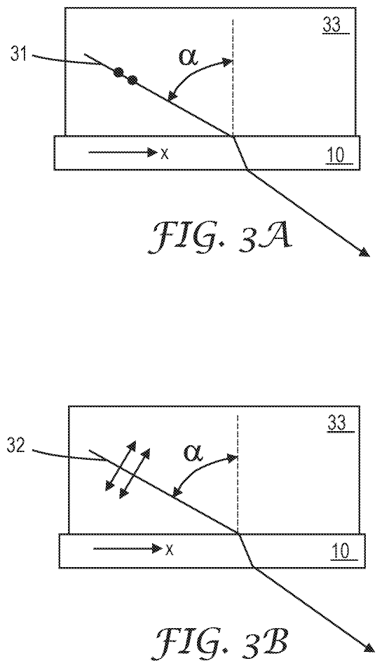

In some aspects, as shown in FIGS. 3A, when an incident light is s-polarized (31) in an incident plane (33) including the in-plane first direction (x-axis), for an incident angle (α) of greater than about 40 degrees, or greater than about 45, or greater than about 50, or greater than about 55 degrees, and for at least one visible wavelength (42), the plurality of polymeric layers (11, 12) of the optical film (10) may have an optical transmittance (T3) of greater than about 50%. In some cases, the optical transmittance (T3) of the plurality of polymeric layers (11, 12) may be greater than about 55%, or greater than about 60%, or greater than about 65%.

As shown in FIGS. 3B, when an incident light is p-polarized (32) in an incident plane (33) that includes the in-plane first direction (x-axis), for an incident angle (α) of greater than about 40 degrees, or greater than about 45, or greater than about 50, or greater than about 55 degrees, and for at least one visible wavelength (42), the plurality of polymeric layers (11, 12) of the optical film (10) may have an optical transmittance (T4) of greater than about 70% when the incident light is p-polarized (32). In some cases, the optical transmittance (T4) of the plurality of polymeric layers (11, 12) may be greater than about 75%, or greater than about 75%, or greater than about 80%, or greater than about 85%.

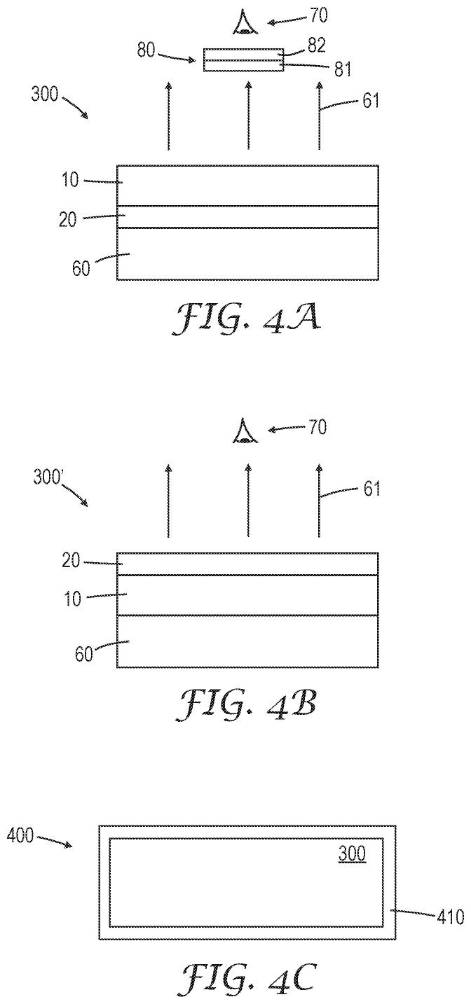

A display system (300, 300′) including the optical construction having a multilayer polymeric optical film (10) and a retarder (20) is shown in FIGS. 4A and 4B. The display system (300, 300′) includes a display (60) configured to emit a polarized image (61) for viewing by a viewer (70). The optical construction including the optical film (10) and the optical retarder (20) may be disposed on the display (60) so that the optical construction is disposed between the display (60) and the viewer (70). The display (60) may be a conventional system that projects a visible light beam or image, and may include liquid crystal display (LCD), or organic light emitting display (OLED).

In some cases, for instance where the display (60) is a public information display located outdoor, the viewer (70) may be looking at the display through a pair of polarized sunglasses (80). The pair of polarized sunglasses (80) may include a linear absorbing polarizer (81) substantially transmitting light having a first polarization state and substantially absorbing light having an orthogonal second polarization state. The pair of polarized sunglasses (80) may further include a substrate (82) supporting the linear absorbing polarizer. The substrate may have an optical transmittance of at least 80% for each visible wavelength in the visible range.

In some cases, the optical retarder (20) may be disposed between the optical film (10) and the display (60) as shown in FIG. 4A. In other cases, the optical film (10) may be disposed between the optical retarder (20) and the display (60) as shown in FIG. 4B. In some embodiments, the optical retarder (20) may include a transverse direction oriented polyethlene terephthalate (TDO PET). In other embodiments, the optical retarder (20) may be a film such as COSMOSHINE SRF (Super retardation film) available from TOYOBO industrial film, Osaka, JP. FIG. 4C schematically shows an outdoor display (400) including the display system (300). The outdoor display (400), in some cases, may be an outdoor advertising display exposed to the sun. The outdoor display may include a housing (410) for housing the display system (300). In some cases, the outdoor display (400) may be a public information display configured to be used outdoors and exposed to the sun. The multilayer polymeric optical film (10) may be substantially polarization insensitive and may be configured to substantially transmit the polarized image (61) emitted by the display (60) shown in FIG. 4A and substantially reflect at least a portion of infrared light received from the sun.

The display system (300) including the multilayer optical film (10) combined with one or more layers of the optical retarder (20) according to one or more embodiments of the disclosure may reduce color mura and obtain sunglass compatibility.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical construction comprising:
an optical film comprising a plurality of polymeric layers numbering at least 10 in total, each of the polymeric layers having an average thickness of less than about 500 nm; and
an optical retarder disposed on the optical film, such that for a substantially normally incident light and for a visible wavelength range extending from about 420 nm to about 680 nm and an infrared wavelength range extending from about 900 nm to about 1100 nm;
for the incident light polarized along each of mutually orthogonal in-plane first and second directions, the plurality of polymeric layers has an optical transmittance of greater than about 60% for at least one visible wavelength in the visible wavelength range and an optical reflectance of greater than about 60% for at least one infrared wavelength in the infrared wavelength range; and for the incident light polarized along at least one of the first and second directions, the optical retarder has an optical retardance of greater than about 1000 nm at the at least one visible wavelength.

2. The optical construction of claim 1, wherein the plurality of polymeric layers and the optical retarder are co-extruded.

3. The optical construction of claim 1, wherein the optical retarder comprises an in-plane slow axis making an angle of between about 30 degrees to about 60 degrees with the first direction.

4. The optical construction of claim 1, wherein the plurality of polymeric layers comprises a plurality of alternating polymeric first and second layers, each of the first and second layers having an index nx along the first direction, an index ny along the second, and an index nz along a third direction orthogonal to the first and second directions, wherein at least at a wavelength of about 633 nm;
for the first layers, a magnitude of a difference between nx and ny is less than about 0.05, and each of nx and ny is greater than nz by at least 0.05; and
for the second layers, a magnitude of a maximum difference between nx, ny and nz is less than about 0.03; and
nx of the first layers is greater than the nx of the second layers by at least 0.05.

5. The optical construction of claim 4, wherein at the least at the wavelength of about 633 nm;
for the first layers, each of the nx and ny is between about 1.6 and about 1.7, and nz is between about 1.45 and about 1.55; and
for the second layers, each of the nx, ny and nz is between about 1.45 and about 1.54.

6. The optical construction of claim 1, wherein for an incident light in an incident plane that comprises the in-plane first direction, for an incident angle of greater than about 40 degrees, and for at least one visible wavelength, the plurality of polymeric layers has an optical transmittance of greater than about 50% when the incident light is s-polarized, and an optical transmittance of greater than about 70% when the incident light is p-polarized.

7. A display system comprising:
a display configured to emit a polarized image for viewing by a viewer; and
the optical construction of claim 1 disposed on the display so that the optical construction is disposed between the display and the viewer.

8. The display system of claim 7, wherein the viewer is wearing a pair of polarized sunglasses.

9. The display system of claim 8, wherein the pair of polarized sunglasses comprises a linear absorbing polarizer substantially transmitting light having a first polarization state and substantially absorbing light having an orthogonal second polarization state.

10. An outdoor display comprising the display system of claim 7.

11. The optical construction of claim 1, wherein for the substantially normally incident light and for the incident light polarized along each of mutually orthogonal in-plane first and second directions, the plurality of polymeric layers has an average optical transmittance of greater than about 60% in the visible wavelength range and an average optical reflectance of greater than about 60% in the infrared wavelength range.

12. The optical construction of claim 1, wherein for the substantially normally incident light and for the incident light polarized along each of mutually orthogonal in-plane first and second directions, the plurality of polymeric layers has an optical transmittance of greater than about 60% for each wavelength in the visible wavelength range and an optical reflectance of greater than about 50% for each infrared wavelength in the infrared wavelength range.

13. The optical construction of claim 1, wherein for the incident light polarized along at least one of the first and second directions, the optical retarder has an optical retardance of greater than about 1000 nm at each at least one blue wavelength, at least one green wavelength, and at least one red wavelength.

14. An outdoor display configured to be used outdoors and exposed to the sun, the outdoor display comprising:
a display configured to emit a polarized image for outdoor viewing by a viewer;
a multilayer polymeric optical film disposed on the display and comprising a plurality of polymeric layers, each of the polymeric layers having an average thickness of less than about 500 nm, the optical film being substantially polarization insensitive and configured to substantially transmit the polarized image emitted by the display and substantially reflect at least a portion of infrared light received from the sun; and
an optical retarder disposed between the optical film and the display and having a retardance of greater than about 1000 nm at at least one visible wavelength.

15. The outdoor display of claim 14, wherein the optical film has an average optical reflectance of greater than about 60% in a visible wavelength range extending from about 420 nm to about 680 nm, and an average optical reflectance of greater than 40% in an infrared wavelength range extending from about 900 nm to about 1100 nm.
